(19) United States
(12) Patent Application Publication
(10) Pub. No.: US 2026/0226356 A1
(43) Pub. Date: Aug. 6, 2026

(54) FUEL COMPOSITION COMPRISING A RENEWABLE BASE AND A PHENOLIC COMPOUND

(71) Applicant: TotalEnergies One Tech, Courbevoie (FR)

(72) Inventor: Nicolas Obrecht, Solaize (FR)

(21) Appl. No.: 19/132,530

(22) PCT Filed: Dec. 1, 2023
(86) PCT No.: PCT/FR2023/051882

§ 371 Date: May 23, 2025

(30) Foreign Application Priority Data
Dec. 1, 2022 (FR) 2212661

(51) Int. Cl. C10L 1/183; C10L 1/02; C10L 10/10

(52) U.S. Cl. CPC C10L 1/1832; C10L 1/02; C10L 10/10; C10L 2200/0484; C10L 2270/02; C10L 2270/04

(57) ABSTRACT

The present invention relates to a fuel composition comprising at least 50% by weight, relative to the total weight of the composition, of one or more paraffin hydrocarbon fractions consisting of fatty acids and/or hydrogenated fatty acid esters (HEFA) and 0.1 to 10% by weight, relative to the total weight of the composition, of one or more phenol compounds of formula (I): (I). The compounds of formula (I) make it possible to increase the self-ignition temperature of the composition. Said composition is useful for powering any internal combustion engine of a land vehicle, watercraft, aircraft or spacecraft, in particular an aircraft or rocket engine.

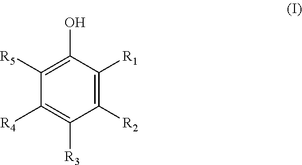

The present invention relates to a fuel composition which can be used inter alia in air transport, and which comprises one or more fractions consisting of hydrogenated fatty acids and/or fatty acid esters in combination with at least one particular phenolic compound.

The present invention also relates to the use of such a composition for fueling a heat engine, notably such as but not limitingly an aircraft or rocket engine.

### PRIOR ART

The fuels used in aeronautics and space propulsion are subject to very strict regulations aimed at ensuring a high level of safety during their use.

Thus, the turbine engines (turbojets and turboprops) that power most aircraft and helicopters (civil or military) use specific fuels known as jet fuels, which are traditionally formulated from hydrocarbon fractions known as kerosene fractions, produced by the distillation of crude oil.

The most widely used reference jet fuel for civil aviation is Jet A-1. Its properties are defined in the international standard ASTM D1655. The physical characteristics of this fuel meet the efficiency and safety criteria required in the air transport field, both for ground operations and for the phases of flight. The main properties are:
a high calorific value of at least 42.8 MJ/kg. This represents the amount of energy released per unit mass of fuel during combustion. This value is very important because it affords the aircraft greater autonomy for a constant on-board mass.
a very low freezing point, which must be below −47° C., allowing the fuel to be stored in a liquid state when the aircraft is cruising, in a very low temperature environment.
a flash point (or temperature above which fuel vapours can ignite in the presence of a flame), which must be greater than 38° C., so as to ensure safe handling of the fuel on the ground.

Other properties such as the sulfur content, acidity or density of the fuel are also defined in the standard ASTM D1655.

The fight against global warming now requires air transport to reduce its fossil carbon dioxide emissions by adopting fuels with a low environmental impact, also referred to as Sustainable Aviation Fuels (SAF). One promising solution is to replace kerosene bases of fossil origin with bases of biological origin, notably bases derived from processes for the hydrogenation of natural esters and fatty acids, known as Hydrogenated Esters and Fatty Acids (HEFA). Specifically, fuels formulated from these bases have characteristics that are relatively close to those of Jet A1 jet fuel, making HEFA bases excellent candidates for the aviation industry.

However, these HEFA bases consist essentially of linear and branched paraffins (alkanes). Their chemical composition, which is free of aromatic and naphthenic hydrocarbons, means that their auto-ignition temperature is significantly lower than that of traditional kerosene-based jet fuels of fossil origin, which gives rise to major safety problems, notably fire risks when the fuel is used in the hot parts of aircraft and rocket engines.

It is thus desirable to increase the auto-ignition temperature of this type of biofuel, in order notably to allow its use in the aeronautical and aerospace industries.

One solution to this problem consists in adding to HEFA bases one or more fuel bases rich in aromatic and/or naphthenic hydrocarbons. However, the aromatic and/or naphthenic fuel bases available usually come from fossil sources, which are not renewable. Furthermore, these bases are available in small quantities, are expensive and require high incorporation rates to have a significant effect on the auto-ignition temperature.

The present invention is directed towards remedying the problems described above.

The present invention is notably directed towards proposing a fuel composition based on hydrogenated fatty acids and/or fatty acid esters (HEFA), which has an increased auto-ignition temperature without having use significant quantities of bases rich in aromatic and/or naphthenic hydrocarbons.

The Applicant has now discovered that the addition, to a fuel base consisting of hydrogenated fatty acids and/or fatty acid esters, of one or more phenolic compounds as defined hereinbelow, in a minimum content of 0.05% by mass, made it possible to significantly increase the auto-ignition temperature of the mixture and thus to formulate a sustainable fuel that is suitable for use in the aeronautical and aerospace industries.

One subject of the present invention is thus a fuel composition comprising:
a) at least 50% by mass, relative to the total mass of the composition, of one or more fractions of paraffinic hydrocarbons consisting of hydrogenated fatty acids and/or fatty acid esters (HEFA); and
b) from 0.1% to 10% by mass, relative to the total mass of the composition, of one or more phenolic compounds corresponding to formula (I) below:

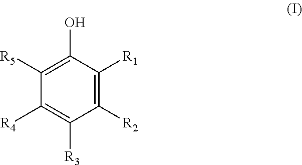

in which the groups R₁, R₂, R₃, R₄ and R₅, which may be identical or different, represent, independently of each other, a hydrogen atom or a linear or branched alkyl group comprising from 1 to 16 carbon atoms,
it being understood that at least one of the groups R₁, R₂, R₃, R₄ and R₅ represents a linear or branched alkyl group comprising from 1 to 16 carbon atoms.

The composition according to the invention has an auto-ignition temperature, measured in accordance with the standard ASTM E659, significantly higher than that of a composition comprising the same bases with the exception of the compound(s) of formula (I).

Thus, the compound(s) of formula (I) can be used to increase the auto-ignition temperature of a fuel composition, in particular of a fuel composition for fueling aircraft and rocket engines.

This increase in the auto-ignition temperature is reflected by a reduction in the risk of fire during use of the composition as a fuel, including at high temperatures as is the case in aircraft and rocket engines. This reduction of the risk of fire advantageously increases the safety of internal combustion engines, in particular the safety of aircraft and rocket engines.

Whereas the auto-ignition temperature measured in accordance with the standard ASTM E659 for a fuel composition consisting solely of hydrogenated fatty acids and/or fatty acid esters (HEFA) is about 200° C., the auto-ignition temperature (measured in accordance with the same standard) of the composition according to the invention is at least 210° C. Preferably, the auto-ignition temperature of the composition according to the invention is greater than or equal to 220° C. and more preferentially greater than or equal to 225° C.

This temperature is achieved without having to add significant amounts of fuel bases rich in aromatic and/or naphthenic hydrocarbons.

Thus, according to a preferred embodiment, the aromatic hydrocarbon content of the composition according to the invention is less than 5% by mass, preferably less than 2% by mass, more preferentially less than 1% by mass, relative to the total mass of the composition.

The term “aromatic hydrocarbons” denotes herein aromatic compounds formed solely from carbon atoms and hydrogen atoms, and free of heteroatoms. In particular, the compounds of formula (I) defined above do not constitute aromatic hydrocarbons within the meaning of the present invention.

According to an embodiment that is also preferred, the content of naphthenic hydrocarbons in the composition according to the invention is less than 5% by mass, preferably less than 4% by mass, relative to the total mass of the composition.

According to a particularly preferred embodiment, the total content of naphthenic hydrocarbons and aromatic hydrocarbons in the composition according to the invention is less than 5% by mass, preferably less than 4% by mass, relative to the total mass of the composition.

The paraffinic hydrocarbon fraction(s) consisting of hydrogenated fatty acids and/or fatty acid esters (HEFA) are bases of biological origin. Thus, the composition according to the invention comprises a predominant amount of biobased materials. It thus has a high eco-material content. The mass content of eco-material in the composition is defined by the following equation:

$$Eco - material content in \% = 100 - ( percentage of non - biobased , non - biodegradable , non - recycled materials ) .$$

According to an advantageous embodiment, the composition has an eco-material content of at least 70% by mass, preferably at least 80% by mass, preferentially at least 90% by mass, and more preferentially at least 95% by mass, relative to the total mass of the composition.

The composition according to the invention also has good properties in terms of calorific value, freezing point and flash point.

It is perfectly suitable for use as a fuel for aircraft and rocket engines, but also more generally for fueling any internal combustion engine used in land, marine, air or space propulsion.

Thus, a subject of the present invention is also the use of the composition according to the invention for fueling an internal combustion engine of a land, sea, air or space propulsion device, and preferably an aircraft or rocket engine.

Other subjects, characteristics, aspects and advantages of the invention will emerge even more clearly on reading the description and the examples that follow.

In the text hereinbelow, and unless otherwise indicated, the limits of a range of values are included in that range, notably in the expressions “comprising between” and “ranging from . . . to . . . ”.

Moreover, the expressions “at least one” and “at least” used in the present description are equivalent to the expressions “one or more” and “greater than or equal to”, respectively.

Finally, in a manner known per se, the term “CN compound or group” denotes a compound or group containing N carbon atoms in its chemical structure.

### DETAILED DESCRIPTION

### The Paraffinic Hydrocarbon Fraction (a)

The composition according to the invention contains at least one paraffinic hydrocarbon fraction consisting of hydrogenated fatty acids and/or fatty acid esters (HEFA).

In a manner known per se, these fractions, commonly referred to as HEFA, consist predominantly of paraffins derived from the hydrogenation of fatty acids and fatty acid esters.

The term “fatty acid” denotes a carboxylic acid comprising a hydrocarbon-based chain containing from 6 to 30 carbon atoms, preferably from 7 to 24 carbon atoms and more preferentially from 8 to 20 carbon atoms.

The term “fatty acid ester” denotes both monoesters and polyesters (notably di- and tri-esters) of the above fatty acids with an alcohol which may be a monoalcohol or a polyol.

According to a preferred embodiment, the paraffinic hydrocarbon fraction(s) (a) consist of hydrotreated vegetable oils (also known as HVO). These are oils of vegetable origin which have undergone successive treatments including hydrotreatment and optional isomerization. The processes for preparing such hydrotreated vegetable oils are known per se.

Examples of suitable vegetable starting materials comprise rapeseed oil, canola oil, sunflower oil, soybean oil, hemp oil, olive oil, linseed oil, mustard oil, palm oil, castor oil and coconut oil.

Patent applications WO 2016/185046 and WO 2016/185047 describe non-limiting examples of methods for obtaining hydrotreated vegetable oil fractions that can be used as fuel bases.

The paraffinic hydrocarbon fraction(s) (a) have a distillation range advantageously within the range from 60 to 350° C., preferably from 100 to 300° C., more preferentially from 120 to 290° C. and better still from 140 to 280° C.

The distillation range of said paraffinic hydrocarbon fraction is determined in accordance with the standard NF EN ISO 3405.

The paraffinic hydrocarbon fraction(s) (a) advantageously have a paraffin content greater than or equal to 90% by mass, preferably greater than or equal to 95% by mass, and better still greater than or equal to 96% by mass, relative to the total mass of the fraction(s) (a).

The term “paraffins” denotes, in a manner known per se, branched alkanes (also referred to as iso-paraffins or isoalkanes) and unbranched alkanes (also referred to as n-paraffins or n-alkanes).

The paraffins present in the paraffinic hydrocarbon fraction(s) (a) according to the invention advantageously comprise from 6 to 18 carbon atoms, preferably from 8 to 17 carbon atoms. Preferably, the paraffinic hydrocarbon fraction(s) (a) consist of at least 80% by mass, more preferentially at least 90% by mass and better still at least 95% by mass of paraffins comprising 8 to 17 carbon atoms.

According to a preferred embodiment, the paraffinic hydrocarbon fraction(s) (a) used in the composition according to the invention contain at least 60% by mass, preferably at least 70% by mass of iso-paraffins, relative to the total mass of the fraction(s) (a). According to a particularly preferred embodiment, they contain at least 80% by mass of iso-paraffins.

The paraffinic hydrocarbon fraction(s) (a) have a content of aromatic compounds preferably of less than or equal to 10 000 ppm by mass, more preferentially of less than or equal to 1500 ppm by mass, even more preferentially of less than or equal to 1000 ppm by mass.

Their content of naphthenic compounds is preferably less than or equal to 40 000 ppm by mass, more preferentially less than or equal to 30 000 ppm by mass.

Their sulfur content is advantageously less than or equal to 10 ppm by mass, preferably less than or equal to 5 ppm by mass. In a particularly preferred manner, the paraffinic hydrocarbon fraction(s) (a) are totally free of sulfur.

The composition according to the invention preferably comprises at least 75% by mass of one or more paraffinic hydrocarbon fractions (a) as described above. Preferably, it contains at least 85% by mass of one or more paraffinic hydrocarbon fraction (a), more preferentially at least 90% by mass and better still at least 95% by mass, relative to the total mass of the composition.

According to a preferred embodiment, the composition according to the invention contains at least 98% by mass, and better still at least 99% by mass of one or more paraffinic hydrocarbon fractions (a) as described above.

### Phenolic Compounds (b)

The composition comprises at least one phenolic compound of formula (I):

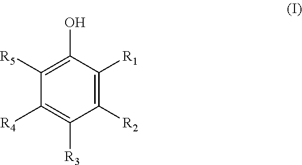

in which the groups R₁, R₂, R₃, R₄ and R₅, which may be identical or different, represent, independently of each other, a hydrogen atom or a linear or branched alkyl group comprising from 1 to 16 carbon atoms, with at least one of the groups R₁, R₂, R₃, R₄ and R₅ representing a linear or branched alkyl group comprising from 1 to 16 carbon atoms.

Preferably, the groups R₁, R₂, R₃, R₄ and R₅, which may be identical or different, represent, independently of each other, a hydrogen atom or a linear or branched alkyl group comprising from 1 to 12 carbon atoms, more preferentially from 1 to 8 carbon atoms and better still from 1 to 6 carbon atoms, at least one of the groups R₁, R₂, R₃, R₄ and R₅ representing such an alkyl group.

According to a preferred embodiment, the groups R₁, R₂, R₃, R₄ and R₅, which may be identical or different, represent, independently of each other, a hydrogen atom or an alkyl group chosen from methyl, ethyl, n-propyl, isopropyl, n-butyl, 2-methylpropyl (isobutyl), 1-methylpropyl (sec-butyl) and 1,1-dimethylethyl (tert-butyl) groups, at least one of the groups R₁, R₂, R₃, R₄ and R₅ representing such an alkyl group.

According to a preferred embodiment, at least two of the groups R₁, R₂, R₃, R₄ and R₅ denote alkyl groups, which may be identical or different, as defined above. Better still, three of the groups R₁, R₂, R₃, R₄ and R₅ denote alkyl groups, which may be identical or different, as defined above, and more preferentially the three groups R₁, R₃ and R₅ denote such alkyl groups, R₂ and R₄ denoting a hydrogen atom.

According to a particularly preferred embodiment, the composition according to the invention comprises 2,4,6-trimethylphenol (CAS No. 527-60-6), which is a compound of formula (I) in which: the groups R₁, R₃ and R₅ represent a methyl group; R₂ and R₄ represent a hydrogen atom:

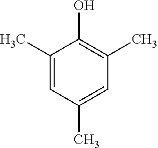

The composition according to the invention comprises the compound(s) of formula (I) in a content ranging from 0.1% to 10% by mass, preferably from 0.1% to 5% by mass, more preferentially from 0.2% to 2% by mass, better still from 0.25% to 0.6% by mass, relative to the total mass of the composition.

According to a preferred embodiment, the composition comprises 2,4,6-trimethylphenol in a content ranging from 0.1% to 10% by mass, preferably from 0.1% to 5% by mass, more preferentially from 0.2% to 2% by mass, better still from 0.25% to 0.6% by mass, relative to the total mass of the composition.

The compounds of formula (I) may be of natural origin. Advantageously, the eco-material content of the composition is further increased when the compound of formula (I) is obtained from compounds of natural origin.

Thus, the phenolic compound(s) of formula (I) can be used to increase the eco-material content of a fuel composition, in particular a fuel composition intended for fueling aircraft and rocket engines.

### The Possible Additives

The composition according to the invention may comprise one or more additives, different from the compounds of formula (I) described above.

This or these additives may be chosen, for example, in a non-limiting manner, from antioxidant, anti-freeze and anti-static additives, corrosion inhibitors, lubricity additives, cold-flow improvers, detergent additives and tracer additives. Antioxidant additives are particularly preferred.

These additives may be incorporated in contents, for each, ranging from a few ppm to 1000 ppm by mass.

### Use of the Composition

The composition according to the invention is useful as a fuel for any internal combustion engine of a propulsion device, notably for land, sea, air or space propulsion.

The composition according to the invention can notably be used for fueling any internal combustion engine in one of the following vehicles: road vehicles, including light vehicles (notably cars) and heavy goods vehicles (trucks of various loads, known as “medium duty” and “heavy duty” trucks, refuse collection vehicles, buses, coaches, etc.) and non-road vehicles (construction or public works machinery, tractors, trains or boats).

According to a preferred embodiment, the composition according to the invention is used for fueling an aircraft or rocket engine.

According to a particularly preferred embodiment, the composition according to the invention is used for fueling a turbojet or turboprop engine in an aircraft, preferably chosen from an aeroplane and a helicopter (civil or military), and more preferentially an aeroplane.

The composition according to the invention may also be used for improving the eco-performance of an internal combustion engine of a land, sea, air or space propulsion device, in particular an aircraft engine or a rocket engine.

For example, the eco-performance of the internal combustion engine may be the reduction in the environmental impact of the internal combustion engine.

Specifically, the amount of compounds of biological origin in the composition according to the invention is significant. As explained above, the amount of fuel bases rich in aromatic and/or naphthenic hydrocarbons of fossil origin and the amount of compound of formula (I) in the composition according to the invention may be low. Thus, the environmental impact of the composition according to the invention is lower than the environmental impact of a fuel composition of fossil origin. The environmental impact of the internal combustion engine fueled with the composition according to the invention is thus reduced.

### Use of the Compounds of Formula (I)

A subject of the present invention is also the use of one or more compounds chosen from the phenolic compounds corresponding to formula (I) below:

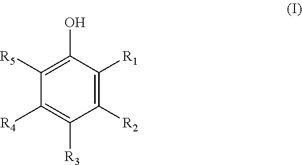

in which the groups R₁, R₂, R₃, R₄ and R₅, which may be identical or different, represent, independently of each other, a hydrogen atom or a linear or branched alkyl group comprising from 1 to 16 carbon atoms,
it being understood that at least one of the groups R₁, R₂, R₃, R₄ and R₅ represents a linear or branched alkyl group comprising from 1 to 16 carbon atoms,
for increasing the auto-ignition temperature of a fuel composition comprising at least 50% by mass, relative to the total mass of the composition, of one or more fractions of paraffinic hydrocarbons consisting of hydrogenated fatty acids and/or fatty acid esters (HEFA).

The auto-ignition temperature is measured in accordance with the method defined in the standard ASTM E659.

The fuel composition is as described above.

The compound(s) of formula (I) are advantageously used in a content ranging from 0.1% to 10% by mass, preferably from 0.1% to 5% by mass, more preferentially from 0.2% to 2% by mass, better still from 0.25% to 0.6% by mass, relative to the total mass of the composition.

### The Method

A subject of the present invention is also a method for propelling a land, sea, air or space movement device equipped with at least one internal combustion engine, which consists in fueling said engine with a fuel composition as described above.

Preferably, said engine is an aircraft or rocket engine, more preferentially a turbojet or turboprop engine fitted in an aircraft or helicopter and more preferentially an aeroplane.

The examples hereinbelow are given as illustrations of the invention and should not be construed in such a way as to limit the scope thereof.

### EXAMPLES

The examples below were conducted using a paraffinic hydrocarbon fraction designated fraction A consisting of hydrogenated esters and fatty acids (HEFA). More precisely, fraction A consists of a hydrotreated vegetable oil (HVO), the characteristics of which are detailed in Table I below:

TABLE I

| | Concentration |
|---|---|
| | by mass |
| Compounds | (%) |
| C8 to C16 N-paraffins | 16.20 |
| C8 to C17 Iso-paraffins | 80.92 |
| Naphthenes | 2.86 |
| Aromatics | 0.02 |

### 1. COMPARATIVE EXAMPLES

Fuel compositions were prepared by adding an aromatic compound (mesitylene) or a naphthenic compound (methylcyclohexane) to fraction A, in the contents detailed in Table II below.

The auto-ignition temperature of each of these compositions was measured, in accordance with the method defined in the standard ASTM E659. The results obtained are also detailed in Table II.

TABLE II

| Compositions | CE0 | CE1 | CE2 | CE3 |
|---|---|---|---|---|
| HEFA content (fraction A) | 100 | 89 | 90 | 99.5 |
| (mass %) | | | | |
| Mesitylene content | — | 11 | — | — |
| (mass %) | | | | |
| Methylcyclohexane content | — | — | 10 | 0.5 |
| (mass %) | | | | |
| Auto-ignition temperature | 203 | 221 | 224 | 205 |
| (° C.) | | | | |

These results show that in order to significantly increase the auto-ignition temperature of fraction A, the aromatic compound and the naphthenic compound must be added in significant amounts, as is the case in the comparative compositions CE1 and CE2. On the other hand, the addition of a low content of naphthenic compound (composition CE3) does not afford a significant increase in the auto-ignition temperature.

### 2. EXAMPLES ACCORDING TO THE INVENTION

Fuel compositions were prepared by adding 2,4,6-trimethylphenol (referred to hereinbelow as 2,4,6-TMP) to fraction A, in the contents detailed in Table III below.

The auto-ignition temperature of each of these compositions was measured, in accordance with the method defined in the standard ASTM E659. The results obtained are also detailed in Table III.

TABLE III

| Compositions | CE0 | C1 | C2 | C3 |
|---|---|---|---|---|
| HEFA content (fraction A) | 100 | 99.9 | 99.75 | 99.5 |
| (mass %) | | | | |
| 2,4,6-TMP content | — | 0.1 | 0.25 | 0.5 |
| (mass %) | | | | |
| Auto-ignition temperature | 203 | 211 | 219 | 217 |
| (° C.) | | | | |

Composition CE0 is a comparative composition (consisting entirely of fraction A), while compositions C1 to C3 are in accordance with the invention.

These results show that the addition of the phenolic compound in accordance with the invention to fraction A in very small amounts affords a significant increase in the auto-ignition temperature. The auto-ignition temperature increases significantly with the 2,4,6-trimethylphenol content and excellent results are obtained at contents of 0.25% and 0.5% by mass (compositions C2 and C3).

Compared with the addition of the aromatic and naphthenic compounds according to Comparative Examples CE1 and CE2, the addition of the phenolic compound according to the invention affords results that are virtually as good at much lower contents.

Compared with the addition of the naphthenic compound according to Comparative Example CE3, said phenolic compound in the same concentrations affords a very significantly higher increase in the auto-ignition temperature of the fuel composition.

1. Fuel composition comprising:
(a) at least 50% by mass, relative to the total mass of the composition, of one or more fractions of paraffinic hydrocarbons consisting of hydrogenated fatty acids and/or fatty acid esters (HEFA); and
(b) from 0.1% to 10% by mass, relative to the total mass of the composition, of one or more phenolic compounds corresponding to formula (I) below: 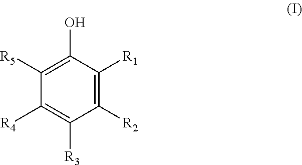
in which the groups R₁, R₂, R₃, R₄ and R₅, which may be identical or different, represent, independently of each other, a hydrogen atom or a linear or branched alkyl group comprising from 1 to 16 carbon atoms,
it being understood that at least one of the groups R₁, R₂, R₃, R₄ and R₅ represents a linear or branched alkyl group comprising from 1 to 16 carbon atoms.

2. Composition according to claim 1 wherein the paraffinic hydrocarbon fraction(s) (a) consist of hydrotreated vegetable oils (HVO).

3. Composition according to claim 1 wherein the paraffinic hydrocarbon fraction(s) (a) have a paraffin content greater than or equal to 90% by mass, relative to the total mass of the fraction(s) (a).

4. Composition according to claim 1 wherein the paraffins present in the paraffinic hydrocarbon fraction(s) (a) comprise from 6 to 18 carbon atoms.

5. Composition according to claim 1 wherein the composition comprises at least 75% by mass of one or more paraffinic hydrocarbon fractions (a), relative to the total mass of the composition.

6. Composition according to claim 1 wherein in formula (I), the groups R₁, R₂, R₃, R₄ and R₅, which may be identical or different, represent, independently of each other, a hydrogen atom or a linear or branched alkyl group comprising from 1 to 12 carbon atoms, and at least one of the groups R₁, R₂, R₃, R₄ and R₅ representing such an alkyl group.

7. Composition according to, claim 1 wherein in formula (I), at least two of the groups R₁, R₂, R₃, R₄ and R₅ denote alkyl groups, which may be identical or different.

8. Composition according to claim 1 wherein the composition comprises 2,4,6-trimethylphenol.

9. Composition according to claim 1 wherein the phenolic compound(s) of formula (I) are of natural origin.

10. Composition according to claim 1 wherein the compound(s) of formula (I) are present in a content ranging from 0.1% to 5% by mass, relative to the total mass of the composition.

11. Composition according to claim 1 wherein the aromatic hydrocarbon content is less than 5% by mass, relative to the total mass of the composition.

12. Composition according to claim 1 wherein the composition comprises one or more additives, different from the compounds of formula (I), selected from the group consisting of antioxidant, anti-freeze and antistatic additives, corrosion inhibitors, lubricity additives, cold-flow improvers, detergent additives, tracer additives, and combinations thereof.

13. Composition according to claim 1 wherein the composition comprises an eco-material content of at least 70% by mass, relative to the total mass of the composition.

14. Method comprising:
fueling an internal combustion engine of a land, sea, air or space propulsion device with the composition defined in claim 1.

15. Method of claim 14 wherein the internal combustion engines is an aircraft engine or a rocket engine.

16. Method of claim 15 comprising improving, with the fueling, the eco-performance of the internal combustion engine.

17. Method of claim 15 comprising
reducing, with the fueling, the environmental impact of the internal combustion engine.

18. (canceled)

19. Method for propelling a land, sea, air or space movement device equipped with at least one internal combustion engine, consisting of
fueling said engine with a fuel composition as defined in claim 1.

20. Method according to claim 19 wherein, said engine is fitted in an aeroplane or a helicopter and the engine is selected from the group consisting of an aircraft engine, a rocket engine, a turbojet engine, and a turboprop engine.

21. Method for increasing the auto-ignition temperature of a fuel composition comprising:
adding at least 50% by mass, relative to the total mass of the fuel composition, of one or more fractions of paraffinic hydrocarbons consisting of hydrogenated fatty acids or fatty acid esters (HEFA).

22. (canceled)
